(19) United States
(12) Patent Application Publication
(10) Pub. No.: US 2012/0196563 A1
(43) Pub. Date: Aug. 2, 2012

(54) PLAN STRENGTH METER FOR A MOBILE DEVICE

(75) Inventors: Daniel Rudich, Montreal (CA); Jaan Leemet, Montreal (CA)

(73) Assignee: ANOMALOUS NETWORKS, INC., Montreal (CA)

(21) Appl. No.: 13/253,655

(22) Filed: Oct. 5, 2011

(30) Foreign Application Priority Data
Jan. 28, 2011 (CA) 2729301

(51) Int. Cl. H04W 4/00

(52) U.S. Cl. 455/405

(57) ABSTRACT

A method and apparatus for tracking user activity on the mobile device, such as voice calls, SMS messages and data downloads. The user activity is tracked against a mobile device plan, which sets limits on the amount of user activity which can take place in a given time period. The amount of activity consumed by the user during the given time period, and how much activity is available for the remainder of the time period is visually indicated on a graphical indicator of the mobile device.

### REFERENCE TO RELATED APPLICATION

This application claims priority to Canadian Application No. 2,729,301, filed Jan. 28, 2011, the disclosure of which is incorporated herein by reference.

### FIELD OF THE INVENTION

The present invention relates to a mobile device indicator for a mobile device user's service plan on the mobile device.

### BACKGROUND

Most users of mobile devices subscribe to a service plan offered by a mobile operator. The service plan outlines limits on services such as data, voice, or Short Message Service (SMS) allowed in a given time period (typically one month) from a particular device.

Typically, once the limit on data, voice or SMS is exceeded for a time period, these services are still available, but the user usually incurs a surcharge for each subsequent use. This surcharge can be exorbitant, and can double the cost of the plan for overages as low as ten percent.

Moreover, most users are unable or unwilling to keep track of the number of SMS messages sent and received, the number of bytes downloaded, or the number of minutes spent talking on the phone. Compounding this problem, is the speed of today's networks. For example, starting a 10 MB video on a High-Speed Packet Access (HSPA) network at 40 Mb/Sec allows the video to be queued in a matter of seconds. Even if one were to start it by mistake, and cancel it in seconds, the transfer may have already taken place. When off network with a standard non roaming package, such a transfer may cost $500 or more, making this a very costly mistake.

US Publication No. 2004/0260630 to Benco et al. teaches a method whereby users are warned if they are close to reaching their plan limits for a given type of activity. Instead, it is made up of warning messages sent when thresholds are crossed or limits reached. This has the disadvantage of only warning the user when it is potentially too late to avoid surcharges.

U.S. Pat. No. 6,131,024 to Boltz teaches a system whereby when a user reaches user-defined limits of usage, the mobile device becomes inoperable, until the user enters a password to reactivate it. This also has the disadvantage of only warning the user when it is potentially too late to avoid surcharges, with the added disadvantage of being inconvenient to the user.

### SUMMARY OF THE INVENTION

According to one aspect of the present invention, there is provided a method for providing an indication of the activity allowed under a mobile plan, the method comprising receiving, at a mobile device, mobile plan information related to the mobile device, the mobile plan information comprising at least one threshold; tracking activity at the mobile device; comparing the tracked activity with the at least one threshold; and updating an indicator on the mobile device based on the comparing step.

According to yet another aspect of the present invention, there is provided a mobile device comprising a communications subsystem and a processor, wherein the communication subsystem and the processor are configured for performing the steps of receiving mobile plan information, the mobile plan information comprising at least one threshold; tracking activity on the mobile device; comparing the tracked user activity with the at least one threshold; and updating an indicator on the mobile device based on the comparing step.

### BRIEF DESCRIPTION OF THE DRAWINGS

The present invention will be better understood after reading the following description of preferred embodiments thereof, made in reference to the appended drawings in which:

FIG. 1 shows an exemplary wireless environment in which the present invention can be practiced.

FIG. 2 shows an exemplary wireless device on which the present invention can be practiced.

FIG. 3 shows a block diagram of a method according to one embodiment of the present invention.

FIG. 4 shows a block diagram of a method according to another embodiment of the present invention.

FIG. 5A shows a plan strength indicator according to one embodiment of the present invention.

FIG. 5B shows a plan strength indicator according to another embodiment of the present invention.

FIG. 5C shows a plan strength indicator according to yet another embodiment of the present invention.

### DETAILED DESCRIPTION

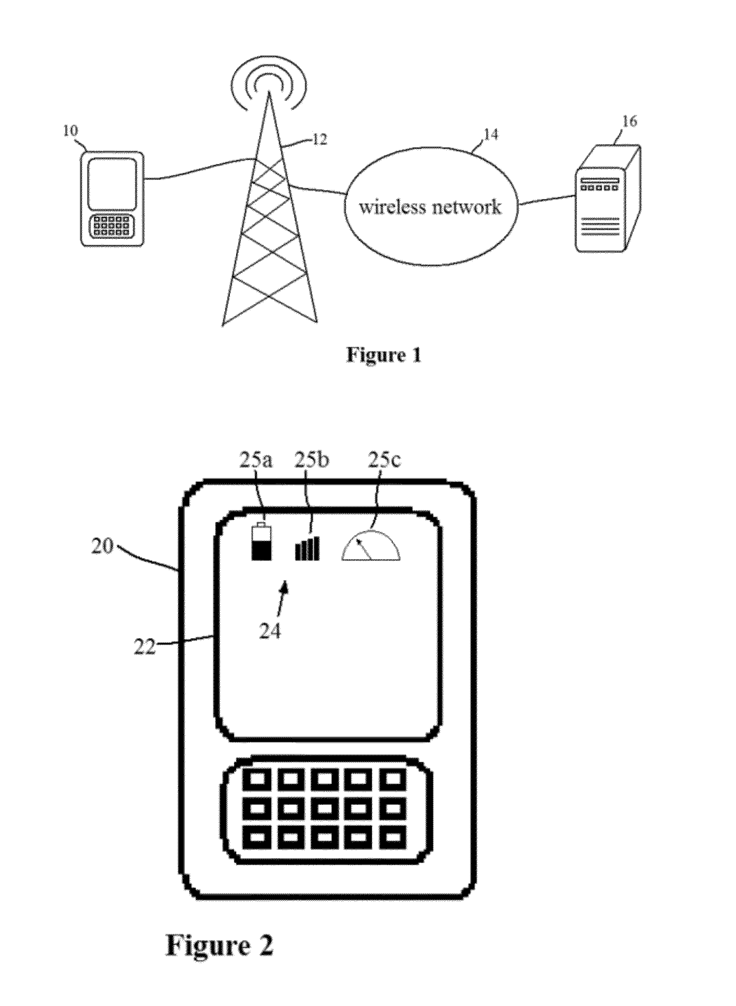

Reference is made to FIG. 1. FIG. 1 shows an exemplary wireless environment, with a mobile device 10, in communication with a base station 12. The base station 12 communicates with wireless network 14, as is known in the art. In this exemplary environment, mobile device 10 may communicate with application server 16.

According to at least one embodiment of the present invention, the application server 16 is a carrier server. A carrier server is a server managed by the carrier company with which the user of mobile device 10 has entered into a service agreement for usage of the mobile device. As would be appreciated by those skilled in the art, a user's mobile plan is part of this service agreement.

Thus, according to at least one embodiment of the present invention, the carrier server 16 has stored thereon, or alternatively has access to data storage having stored thereon, information about the user's mobile plan. Upon requests by the mobile device, the carrier server can provide information about the user's mobile plan to the mobile device. According to at least one embodiment, the carrier server 16 authenticates mobile device 10 before sending plan information. Authentication techniques are known in the art.

The plan information typically includes at least a start date, a duration, a number of voice minutes allowed, a number of SMS messages allowed, and a number of bytes allowed. As would be appreciated by those skilled in the art, other information can be included in the plan information. This additional information can include, but is not limited to, costs for additional minutes, costs for additional messages, and costs for additional bytes, as well as costs for roaming.

Once the mobile device 10 has received the plan information from carrier server 16, the mobile device can start displaying the plan strength meter.

The plan strength meter can also be displayed based on data manually entered by the user to describe the plan, or received from a corporate server that manages these plans for the mobile workforce. Whether the plan data comes from the carrier or an alternate site or method, the signal strength meter will have the information it needs to display.

According to at least one embodiment, the plan strength meter is displayed in the status area of the mobile device's display. For the purposes of the present description, the term “status area” will refer to the portion of a mobile device's display other indicators such as battery and signal strength indicators reside. FIG. 2 shows an example of a mobile device and the status area of the display.

In FIG. 2, the mobile device 20 has a display 22. At the top of display 22, status area 24 includes indicators 25a, 25b and 25c. Indicator 25a is a typical battery level indicator, and indicator 25b is a typical signal strength indicator. Indicator 25c is a needle-type indicator which could be used as an indicator for plan strength according to the present disclosure. Other types of indicators are known in the art.

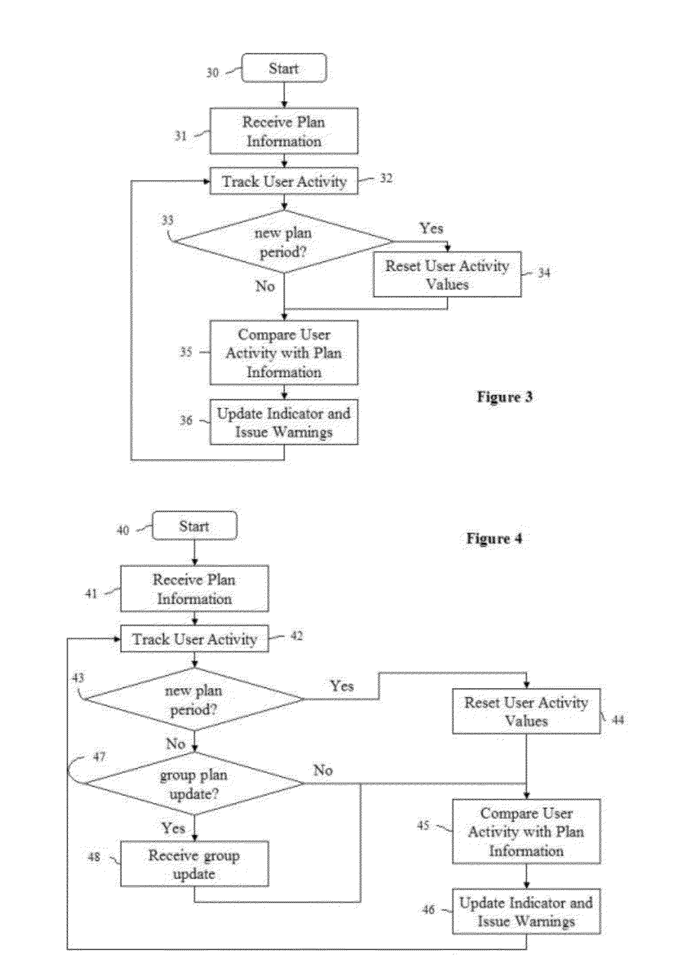

Reference is now made to FIG. 3, which shows a block diagram of one embodiment of a method according to the present disclosure.

At 30, the method starts. At step 31, the mobile receives the plan information. As discussed above, this is done in one embodiment by receiving the plan information from a carrier server. However, the present disclosure contemplates other methods of receiving the plan information. For example, the plan information could be entered manually in the mobile device by the user.

At 32, the mobile device starts to track user activity. More specifically, a tracking agent keeps track of all user activities on the mobile device related to the plan. According to at least one embodiment, the tracking agent is software module running on the mobile device, with access to the data necessary to keep track of user activities.

The tracking agent must first determine which values will be tracked. This information will be available from the plan information. For example, if the plan information sets limits on the number of voice minutes, SMS messages, and bytes downloaded, the tracking agent will keep track of the number of voice minutes, SMS messages, and bytes downloaded. This can be performed in a number of ways, as is known in the art. For example, according to at least one embodiment, the tracking agent could provide a callback function to the mobile device's operating system, such that the callback function is invoked after tracked activities. Thus, after a voice call, the tracking agent would be invoked to add the length of the voice call to its running total for voice minutes. Other methods would be known to those skilled in the art.

At step 33, the mobile device checks whether a new plan period has just started. This is done based on the plan information received in step 31. As would be appreciated by those skilled in the art, the plan information should include the dates on which new plan periods begin. Typically, mobile plans are based on monthly billing periods. Therefore, typically, new plan periods begin on the first of every month. However, the present method can be implemented for any plan period.

If a new plan period is just beginning, as determined at step 33, the activity values are reset to zero at step 34.

At step 35, the tracked user activities are compared against allowed plan values. For example, if the tracking agent has recorded 100 minutes of voice calls since the beginning of the last plan period, and the mobile plan allows for 250 minutes of voice calls, it is determined that 150 minutes of voice calls are available for the current plan period. Similar calculations are performed for other types of user activity such as SMS messages and data.

At step 36, the indicator is updated with the values computed in step 35, in order to reflect how much user activity is available for the current period based on the mobile plan information. The appearance of the indicator and how it is updated to reflect the availability of user activity is discussed in greater detail below.

After step 36, the method returns to step 32 where the tracking agent keeps on tracking user activity.

According to at least one embodiment of the present invention, the present method is adapted to group plans. As is known in the art, a group plan is a plan which allows members of a group to have shared limits for user activities such as voice calls, SMS messages and data. For example, instead of having a plan allowing each of Alice and Bob to have 500 minutes, it might be preferable to have a plan where both Alice and Bob can share 1000 minutes.

However, as would be appreciated by those skilled in the art, the above method would not perform well with such plans. A block diagram of a method according to one embodiment of the present disclosure which is adapted to group plans is shown in FIG. 4.

The method starts at 40, and at step 41, the mobile device receives the plan information, as in the case of FIG. 3. At step 42, the mobile device starts to track user activity as described above, and at step 43, the mobile device checks whether a new plan period is starting, also as described above.

If a new plan period is starting, the method moves on to step 44, where the user activity values are reset to zero, and the method continues as it would under the embodiment described in FIG. 3.

If a new plan period is not starting, the mobile device checks whether it is time to perform a group update at step 47. A group update could be triggered by a number of things, depending on the embodiment of the method being practiced. For example, according to one scenario, a group update may be scheduled at specific time periods, such as at 8 AM every morning. In another embodiment, the group update may occur based on how much user activity has been accumulated in the current plan period. For example, if 10% of the user activity allowed under a plan has been consumed, a group update may be triggered.

If it's not time to perform a group update, the method moves on to step 45 where the user activity is compared to plan information, as described above.

Otherwise, the mobile device performs a group update at step 48. The group update consists of obtaining user activity information from other members of the group in order to properly reflect the amount of activity recorded against the current plan.

The group update can be performed in a number of ways. In one example, group updates are performed amongst members of the groups. Specifically, in this embodiment, a mobile device looking to perform a group update first checks the identity of the group members. This information is provided, according to at least one embodiment, in the plan information.

The mobile device then attempts to communicate with each mobile device of the group, in order to request user activity information as compiled on each of the mobile devices.

Such communications between mobile devices is known in the art and can take various forms. Under one scenario, the mobile device requesting the information creates a socket connection, PIN to PIN, or sends an MMS or SMS message of a predefined format to the mobile device from which the information is requested. This mobile device with another SMS message, also of a predefined format, and including the information requested. However, other means of communicating between mobile devices are known and the present invention is not limited to a particular means of communication. The appropriate means of communication can be selected based on what is supported by the device

In another embodiment, the group user activity information is maintained at an application server. According to this embodiment, when a mobile seeks to perform a group update, it sends a request to an application server. The request should include a group identifier, or alternatively, a mobile device identifier, to allow the server to properly determine which group the mobile device belongs to. In response to the request, the server sends the mobile device the group user activity information. The group user activity information may just provide the total group activity, or may be broken down on a per-user basis.

The mobile device may also send the application server its own user activity information, for the application server to disseminate to other members of the group. As would be appreciated by those skilled in the art, this operation may be performed independently from the request for group user activity, but it could also be performed at the same time.

In yet another embodiment, the group user activity information is maintained on a carrier server. As discussed above, a carrier server is a server maintained by the company with which a user has entered into a mobile service agreement. As would be appreciated by those skilled in the art, this company also keeps track of the activities of the user, as it needs to do so for billing purposes. Accordingly, the present method may take advantage of this by requesting the user activity from the carrier server, in the event that the carrier server makes this information available.

As would also be appreciated by those skilled in the art, in this embodiment, there is no need for the mobile device to track its own user activity, as it may request user activity information—including that of its own user—from the carrier server. Alternatively, the mobile device may track user activity, and obtain group activity information from the carrier server. In this last scenario, the mobile device may simply track user activity in between group updates, or may use user activity information from the carrier to confirm its own activity tracking.

Returning now to FIG. 4, after the group update has been performed and the mobile device knows how much user activity under the group's plan, the group user activity is compared against the plan information in step 45. Step 45 of FIG. 4 is analogous to step 35 in FIG. 3. At step 46, the indicator is updated and warnings are issued if needed. Then, the method returns to step 42 where the user activity is tracked.

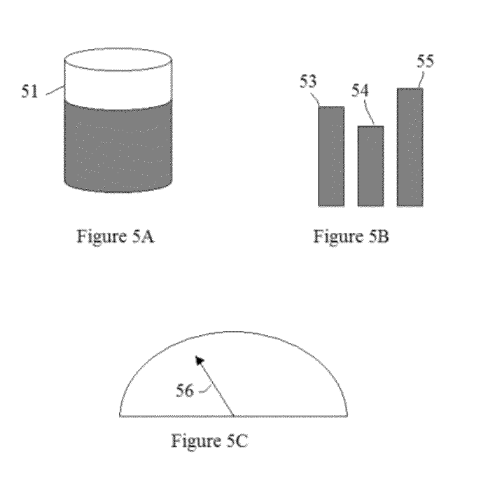

Reference is now made to FIGS. 5a, 5b and 5c, which show different indicators according to various embodiments of the present invention.

FIG. 5A shows a simple container type indicator 51. This indicator does not allow to distinguish between how much user activity there has been under different aspects of the mobile plan. However it gives a simple, and obvious indication of how much of the total plan allowances have been consumed by the user. In the example shown, the grayed-out portion of the indicator 51 represents the proportion of the plan allowances that have been consumed, and the white portion of the indicator 51 represents the proportion of the plan allowances which are still available.

FIG. 5B shows an indicator composed of three sub-indicators, 53, 54 and 55. Each of the three sub-indicators represents the user activity for different aspects of the mobile plan. For example, in one embodiment, sub-indicator 53 represents voice, sub-indicator 54 represents SMS messages, and sub-indicator 55 represents data.

FIG. 5C shows a needle type indicator 56. As in the case of indicator 51, indicator 56 only provides a global view of the activity consumed under the plan. The position of the needle in indicator 56 moves to the right as more activity occurs.

However, indicators 51, 53, 54, 55 and 56 are provided as examples only, and those skilled in the art will appreciate that other types of indicators are within the scope of the present disclosure.

The present disclosure further contemplates that the tracking of user activity can be performed in various ways, as is known in the art. While the present disclosure is not limited to any particular method of tracking user activity, the following is provided for illustrative purposes.

According to at least one embodiment, the mobile device includes an operating system which allows for callback functions to be registered by third party applications. For examples, callback functions could be registered to be called following each of the user activities being tracked. One callback function could be registered to be called following the completion of a voice call. This callback function would add the length of the just completed voice call to a running total. Similarly, after an SMS message is sent or a UDP packet over a socket, a callback function would increment the running total of the number of SMS messages sent by one, and after a data download, another callback function would add the size of the data download to a running total of data downloads. However other means of tracking user activity are known and the present invention is not so limited.

The above describes various embodiments of methods, systems and apparatuses for practicing the present invention. Those skilled in the art will appreciate that none of the embodiments described above limit the scope of the present invention, which is defined by the claims below.

We claim:

1. A method for providing an indication of the activity allowed under a mobile plan, the method comprising:
receiving, at a mobile device, mobile plan information related to the mobile device, the mobile plan information comprising at least one threshold;
tracking activity at the mobile device;
comparing the tracked activity with the at least one threshold;
updating an indicator on the mobile device based on the comparing step.

2. The method of claim 1, further comprising, prior to the receiving step, sending a request to a carrier or enterprise server for mobile plan information related to the mobile device.

3. The method of claim 2, wherein the mobile plan information is received from the carrier or enterprise server.

4. The method of claim 1, wherein the activity comprises voice calls, Short Message Service (‘SMS’) messages, data downloads and roaming.

5. The method of claim 4, wherein the at least one threshold comprises at least one of a threshold for the number of voice call minutes, a threshold for the number of SMS messages, a threshold for the amount of data downloads, and a threshold for roaming.

6. The method of claim 1, wherein the plan information further comprises a plan period, and further comprising the steps of:
checking whether a new plan period has started;
if a new plan period has started, resetting the tracked activity to zero.

7. The method of claim 1, wherein the mobile plan is a group plan and wherein the mobile device is part of a group of mobile devices, the group of mobile devices sharing the group plan, and further comprising the steps of:
checking whether an update of the group plan activity should be performed;
if an update of the group plan activity should be performed, receiving activity data for each mobile device of the group of mobile devices;
adding the activity data for each mobile device of the group of mobile devices to the tracked activity.

8. The method of claim 7, wherein the step of checking whether an update of the group plan activity should be performed comprises one of:
checking how much time has elapsed since the last update of the group plan activity; and
checking how much activity has occurred on the mobile device since the last update of the group plan activity.

9. The method of claim 7, wherein the step of receiving activity data for each mobile device of the group of mobile devices comprises:
requesting from each of the mobile devices of the group of mobile devices, activity data;
receiving activity data from each of the mobile devices of the group of mobile devices.

10. The method of claim 7, wherein the step of receiving activity data for each mobile device of the group of mobile devices comprises:
requesting from an application server, activity data for each of the mobile devices in the group of mobile devices;
receiving activity data for each of the mobile devices in the group of mobile devices from the application server.

11. The method of claim 7, wherein the step of receiving activity data for each mobile device of the group of mobile devices comprises:
requesting from a carrier server, activity data for each of the mobile devices in the group of mobile devices;
receiving activity data for each of the mobile devices in the group of mobile devices from the carrier server.

12. The method of claim 5, wherein the indicator provides an indication for each of voice calls, SMS messages, and data downloads.

13. A mobile device comprising:
a communications subsystem;
a processor;
wherein the communication subsystem are configured to perform the steps of:
receiving mobile plan information, the mobile plan information comprising at least one threshold;
tracking activity on the mobile device;
comparing the tracked activity with the at least one threshold;
updating an indicator on the mobile device based on the comparing step.

14. The mobile device of claim 13, wherein the communications subsystem and the processor further perform the steps of sending a request to a carrier server for mobile plan information and receiving the mobile plan information from the carrier server.

15. The mobile device of claim 13, wherein the activity comprises voice calls, Short Message Service (‘SMS’) messages, data downloads and roaming.

16. The mobile device of claim 15, wherein the at least one threshold comprises at least one of a threshold for the number of voice call minutes, a threshold for the number of SMS messages, a threshold for the amount of data downloads, and a threshold for roaming.

17. The mobile device of claim 13, wherein the plan information further comprises a plan period, and wherein the communications subsystem and the processor are further configured to perform the steps of:
checking whether a new plan period has started;
if a new plan period has started, resetting the tracked activity to zero.

18. The mobile device of claim 13, wherein the mobile device is part of a group of mobile devices, the group of mobile devices sharing a group plan, and wherein the communications subsystem are further configured to perform the steps of:
checking whether an update of the group plan activity should be performed;
if an update of the group plan activity should be performed, receiving activity data for each mobile device of the group of mobile devices;
adding the activity data for each mobile device of the group of mobile devices to the tracked activity.

19. The mobile device of claim 18, wherein the communications subsystem and the processor are further configured to perform the steps of:
requesting from each one of the mobile devices of the group of mobile devices, user data;
receiving activity data from each of the mobile devices of the group of mobile devices.

20. The mobile device of claim 18, wherein the communications subsystem and the processor are further configured to perform the steps of:
requesting from an application server, activity data for each of the mobile devices in the group of mobile devices;
receiving activity data for each of the mobile devices in the group of mobile devices from the application server.

21. The mobile device of claim 18, wherein the communications subsystem and the processor are further configured to perform the steps of:
requesting from a carrier server, activity data for each of the mobile devices in the group of mobile devices;
receiving activity data for each of the mobile devices from the carrier server.

22. The mobile device of claim 16, wherein the indicator provides an indication for each of voice calls, SMS messages, data downloads and roaming.
